(19) United States
(12) Patent Application Publication
(10) Pub. No.: US 2025/0250806 A1
(43) Pub. Date: Aug. 7, 2025

(54) DOOR GUIDING SYSTEM

(71) Applicant: Robert J. Delaney, Dillion, CO (US)

(72) Inventor: Robert J. Delaney, Dillion, CO (US)

(21) Appl. No.: 18/432,325

(22) Filed: Feb. 5, 2024

(51) Int. Cl. E04G 21/16

(52) U.S. Cl. CPC E04G 21/16

(57) ABSTRACT

Method and apparatus for guiding and moving a door through clutching devices placed in a latch bore and hinge cutout of the door. The first clutching device includes a grasping member, an opposing anchor, and a plate insert positioned there between. The secondary clutching device incorporates a grasping member, at least one opposing anchoring pin, and a hinge insert positioned between the grasping member and the anchoring pins. Inserting the first clutching device into the latch bore and the second clutching device into a selected hinge cutout of the door allows a user to lift, stabilize, or otherwise manipulate the door as required. The system contacts the door at locations not normally painted or subjected to surface treatments, thereby enabling the door to be safely and easily moved by a user without marring the surface thereof.

### BACKGROUND

The realm of accessories designed to assist painters in painting doors is limited, primarily consisting of unwieldy, expensive devices composed of various mechanical components. Some are structured to grip the door from the bottom panel but lack the capability to enable users to freely handle a freshly painted door. In fact, only a handful of accessories are suitable for manipulating freshly painted doors, and among these, very few are remotely cost-effective.

Of the tools capable of facilitating the manipulation of a door, the gripping hand tool is notably advantageous and cost-effective. Gripping hand tools have evolved from basic clamps and levers to sophisticated panel gripping systems that are meticulously engineered to provide precise clamping force for manipulating materials like wood and stone. While gripping hand tools effectively assist in handling wooden and stone materials, they are excessively engineered for the task of freely manipulating freshly painted doors. Nevertheless, despite their significant benefits, gripping hand tools, although proficient in handling wooden and stone materials, are overly designed for the delicate task of maneuvering freshly painted doors. More significantly, they hinder the painting process by impeding on surfaces, rendering them impractical for use by painters in the field. This becomes more apparent when dealing with a freshly painted door, where any imprecision or impediment to the painting process can result in noticeable defects such as scratches, scuffs, and blemishes. Consequently, while skilled artisans need the precision that comes with gipping hand tools they typically refrain from using them to manipulate recently freshly painted doors to avoid unintentional defects.

To emphasize, if not handled with care, imperfections necessitate further attention, commonly requiring the application of another coat of paint-a process that is both time-consuming and costly. In fact, interior painters frequently encounter this issue, prompting some to resort to using their fingers for manipulating freshly painted doors. This involves placing a finger in the latch bore intended for the latch of the handle and on the surface of the hinge cutout where the hinge is meant to be affixed. Unfortunately, this method is far from ideal, often resulting in slips and loss of grip on the door, thereby increasing the likelihood of damage to the door and defects in the paint.

In response to this challenge, various alternatives have emerged to address the handling of freshly painted doors without introducing undesirable defects. However, these alternatives have encountered drawbacks, either due to impracticality or inefficiency. One notable example is the door stand, a tool designed to secure two doors together for painting purposes. These door stands are typically available in kits that include multiple stands and floor spacers. The floor spacers are affixed to the bottom surface of the doors, while the door stands are used to connect and hold two doors together during the painting process. Despite appearing as a practical solution, these kits have significant flaws. They require two doors to be of any use and become immovable once paint is applied until it dries. This system has evident limitations, and while effective for stabilizing two doors during painting, it proves impractical and involves more effort than necessary to complete the task.

Accordingly, there is a continued need for improvements in the art to address these and other needs.

### SUMMARY

Embodiments disclosed herein address the above stated needs by providing a door guiding system and method of use for translocating a door.

Without limitation, some embodiments provide a first clutching apparatus and a second clutching apparatus. The first clutching apparatus includes a first grasping member, an anchor positioned opposite the first grasping member, and a plate insert positioned between the first grasping member and the anchor. The second clutching apparatus includes a second grasping member, at least one anchoring pin positioned opposite the second grasping member, and a hinge insert positioned between the second grasping member and the at least one anchoring pin.

These and other features and advantages of various embodiments can be understood from a review of the following detailed description in conjunction with a review of the accompanying drawings.

### BRIEF DESCRIPTION OF THE DRAWINGS

FIG. 1 is a left-side perspective view of a first clutching apparatus constructed and operated in accordance with some embodiments of the present disclosure.

FIG. 2 is a right-side perspective view of a second clutching apparatus constructed and operated in accordance with some embodiments of the present disclosure.

FIG. 3 is a front elevational view of a door in conjunction with the elements from FIGS. 1 and 2 according to further embodiments of the present disclosure.

FIG. 4 is an isometric depiction of the arrangement of FIG. 3.

FIG. 5a is a right-side view of a first clutching apparatus in accordance with another embodiment of the present disclosure.

FIG. 5b is a front, side view of the embodiment of FIG. 5a.

FIG. 5c is a rear view of the embodiment of FIG. 5a.

FIG. 6a is a left-side view of a second clutching apparatus in accordance with another embodiment of the present disclosure.

FIG. 6b is a front, side view of the embodiment of FIG. 6a.

FIG. 6c is a rear view, side view of the embodiment of FIG. 6a.

FIGS. 7a and 7b show hinges of the related art that can be installed onto the door of FIGS. 3-4 in some embodiments.

FIG. 8a shows the use of the hinge from FIG. 7a to mount the door to a doorframe in accordance with the related art.

FIG. 8b is a side view of the door to illustrate further aspects of a hinge cutout thereof.

FIG. 9 is an exploded view of another second clutching apparatus to illustrate yet another attachment configuration that can be carried out in further embodiments.

FIG. 10a shows the door of FIGS. 3-4 in conjunction with an installed door latch assembly in accordance with the related art.

FIG. 10b is an end view of the door to illustrate further aspects of a plate cutout thereof.

FIG. 11 is an exploded view of another first clutching apparatus to illustrate yet another attachment configuration that can be carried out in further embodiments.

### DETAILED DESCRIPTION

The present disclosure relates generally to lifting devices for doors, and more specifically to a system and method for guiding and translocating doors, featuring clutching apparatuses.

As explained below, certain embodiments offer a system for guiding and translocating a door featuring at least two clutching apparatuses designed to aid a user in the lifting and moving doors, especially those that have been freshly painted. In these embodiments, this lifting is accomplished by inserting a first clutching apparatus in a bore of a door configured to receive a handle and a hinge cutout of the same door configured to receive a typical hinge. Each clutching apparatus may be positioned horizontally in its respective location. Subsequently, when a user applies a lifting force to the clutching apparatuses the user may then freely manipulate the door at any desired placement. The clutching apparatuses may use friction generated by anchoring members and/or pins thereon to maintain placement within its affixing (or contacting) surface(s) and avoid inadvertent disengagement of the door lifting and supporting system from the door.

The words “for example” and “exemplary” are used herein to mean “serving as an example, instance, or illustration.” Any embodiment described herein as “for example” or “exemplary” is not necessarily to be construed as preferred or advantageous over other embodiments.

The flowcharts and block diagrams in the following Figures illustrate the architecture, functionality, and operation of possible implementations of systems, methods and computer program products according to various embodiments of the present invention. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

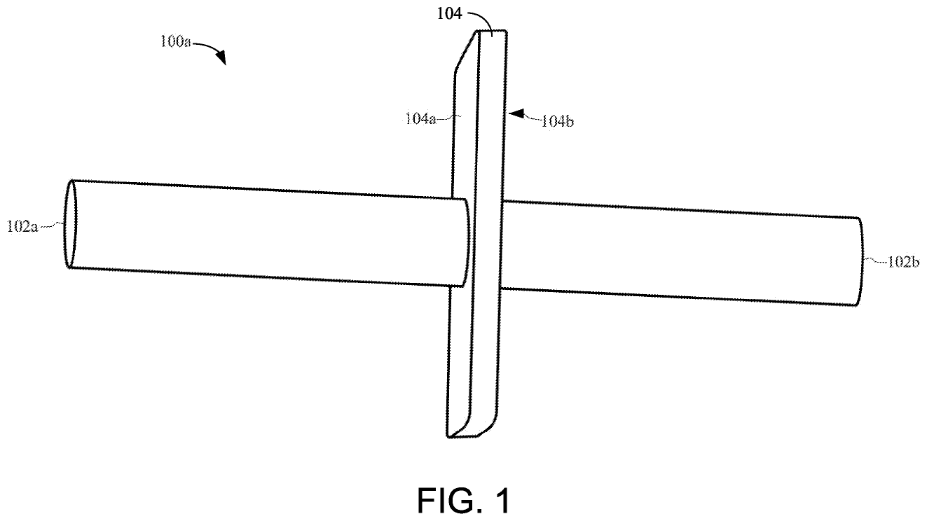

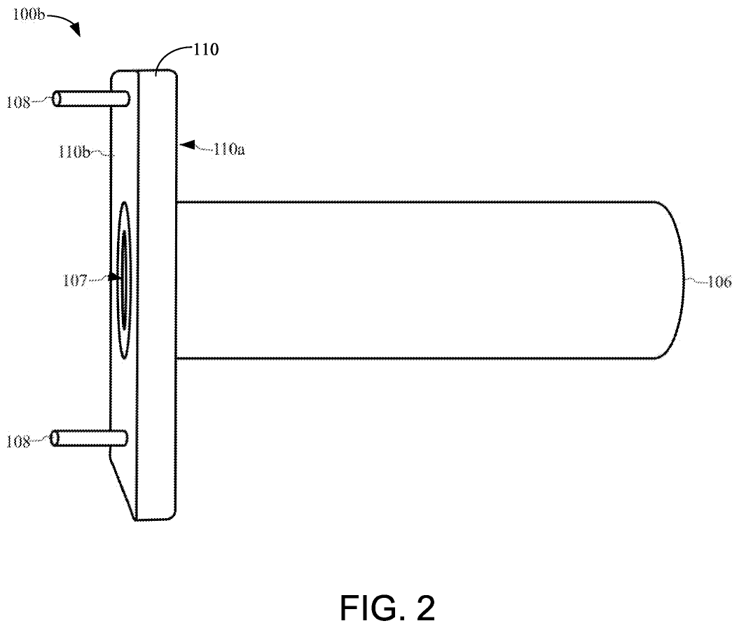

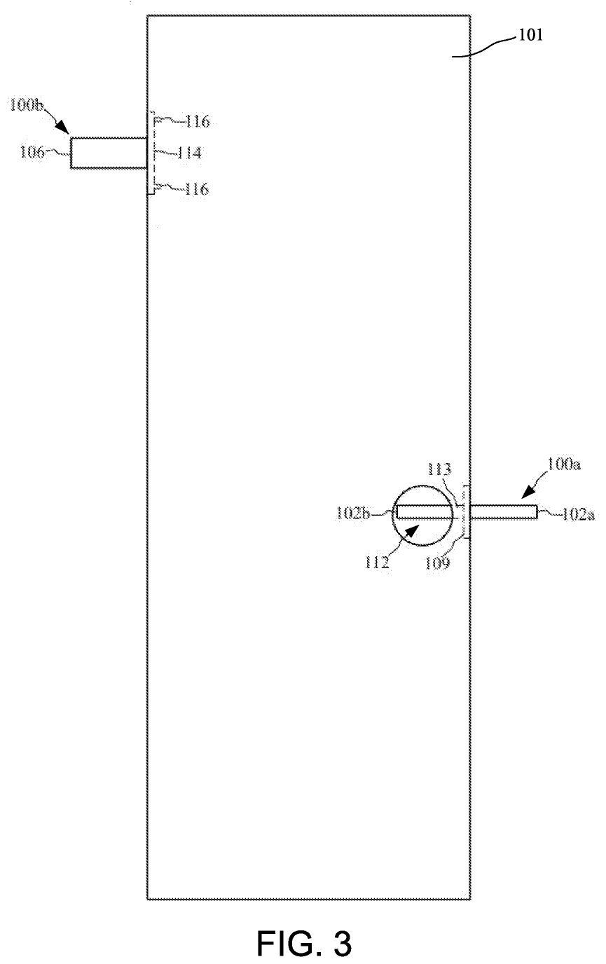

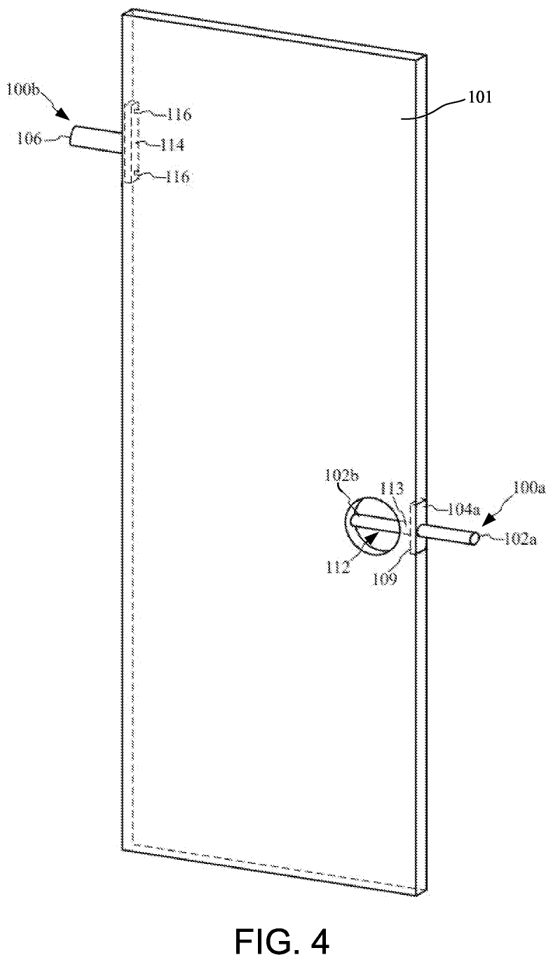

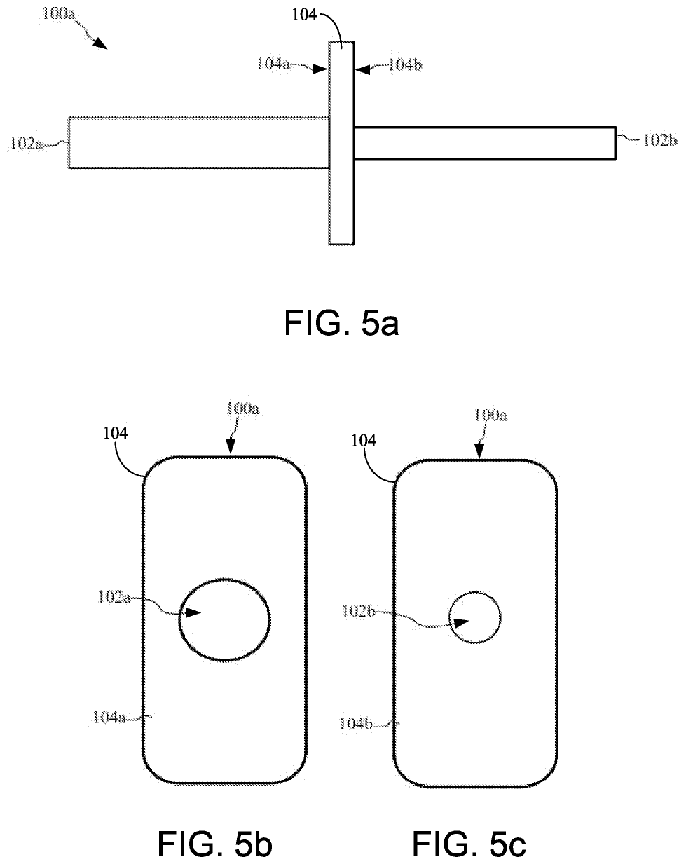

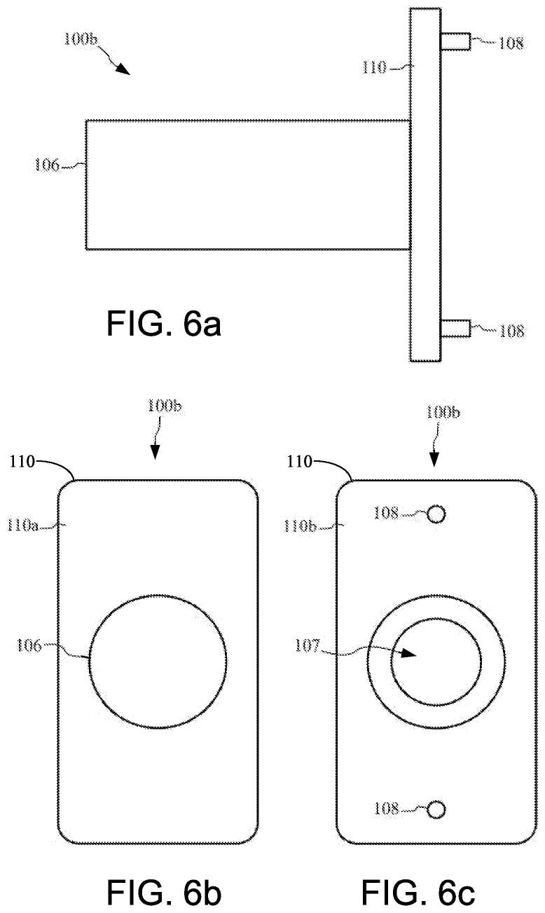

Turning now to the drawings, FIG. 1 illustrates a first clutching apparatus 100a of a system for guiding and translocating a door 101 according to some embodiments of the present disclosure. For reference, FIG. 2 illustrates a second clutching apparatus 100b of the system that may be used in conjunction with the first clutching apparatus 100a of FIG. 1. FIGS. 3 and 4 show the respective apparatuses 100a, 100b of the system in conjunction with a door 101. FIGS. 5a through 5c show an alternative embodiment for the first clutching apparatus 100a, and FIGS. 6a through 6c show an alternative embodiment for the second clutching apparatus 100b. Aspects of these various elements will be discussed in turn below.

The first clutching apparatus 100a of FIG. 1 is shown to include a first grasping member 102a, an anchor 102b, and a plate insert 104 with opposing surfaces 104a, 104b. The first grasping member 102a, anchor 102b, and plate insert 104 may be fabricated from separate components that are subsequently joined together or may be fabricated from a single unitary piece to provide a unified whole. The apparatus 100a, along with other aspects of the system, may be fabricated using any number of suitable processes including but not limited to injection molding, 3D printing, machining, etc. The first clutching apparatus 100a of FIG. 1 may be comprised of any suitable material, including but not limited to, acrylic, plastic, or metal, or any combination of materials.

The first clutching apparatus 100a may be formed of any suitable material capable of sustaining the weight of solid or hollow core doors. The first grasping member 102a may be of substantially any length or shape, and may comprise a smooth, contoured, or textured outer surface as required. In some embodiments, the first grasping member 102a provides an outer gripping surface for a first hand of a user. In some embodiments, the first grasping member 102a may comprise a hollow core (not shown), while in other embodiments the first grasping member 102a may be comprised of a solid material throughout.

The first grasping member 102a may be contoured to fit the curvature of the user's fingers (not shown) or may be smooth and substantially cylindrical as depicted in the embodiment of FIG. 1. In yet other embodiments, the first grasping member 102a may comprise a contact surface having increased friction properties. The friction may be caused by a material configured to improve the user's grip on the surface in contact with the user's hand. Such materials can include sandpaper, rubber, or other materials, and may be adhered to, fastened to, or otherwise joined with the outer surface of the first grasping member 102a. Alternatively, the increased friction force may be facilitated by a material embedded in the first grasping member 102a or by protrusions (not shown) extending from the outer surface of the first grasping member 102a.

In some embodiments, the first grasping member 102a may be characterized by a length falling within a range of 0.1 inches (0.254 cm) to 2.875 inches (7.3025 cm). Other lengths may be used as desired, depending upon the requirements of a given application.

In some embodiments, the first grasping member 102a may have a diameter of 0.5 inches (1.27 cm) to 1 inch (2.54 cm), which generally corresponds to standard diameter ranges of typical latch bores such as denoted at 113 for door 101 in FIGS. 3-4. In other embodiments, the first grasping member 102a may have a diameter greater than 1 inch (2.54 cm). In some embodiments the diameter of the first grasping member 102a may be distinct from the diameter of the anchor 102b, as generally illustrated in the embodiment of FIG. 5a. Alternatively, each of the first grasping member 102a and the anchor 102a can have substantially the same diameter, as generally shown in FIG. 1.

In some embodiments, the diameter of the first grasping member 102a may be limited to the circumference of a latch bore such as the latch bore 113 (see FIGS. 3-4).

The anchor 102b of the first clutching apparatus 100a may be of any shape and may be smooth, contoured, or textured as required. The anchor 102b may be comprised of the same material as the first grasping member 102a or may be comprised of a material distinct from the first grasping member 102a. In some embodiments, the anchor 102b may configured to maintain the first clutching apparatus 100a in a bore aperture 112 (FIGS. 3 and 4) of a door 101 (as seen in FIGS. 3 and 4). The anchor 102b may maintain the first clutching apparatus 100a in the bore aperture 112 through friction between the anchor 102b and an inner surface of the bore aperture 112. In other embodiments, the anchor 102b passes through a latch bore 113 (or edge bore) to enter the bore aperture 112 and an outer surface of the anchor 102b that is in contact with a contact surface of the latch bore 113 creates an additional friction force for maintaining the first clutching apparatus 100a in the bore aperture 112.

In some embodiments, the anchor 102b may be contoured to insertingly engage the bore aperture 112, while in other embodiments, the anchor 102b may be smooth and cylindrical as depicted in the embodiment of FIG. 1. In yet other embodiments, the anchor 102b may further comprise a contact surface configured to increase friction between the anchor 102b and the bore aperture 112. The contact surface may be comprised of a textured material, such as sandpaper or rubber, and may adhere to, be fastened to, or otherwise join the anchor 102b to prevent inadvertent disengagement of the anchor 102b from the bore aperture 112. Alternatively, in some embodiments the increased friction on the contact surface may be caused by a material embedded in the anchor 102b or by protrusions (not shown) extending from the anchor 102b.

In some embodiments, the anchor 102b may be characterized by a length falling within a range of 0.1 inches (0.254 cm) to 2.875 inches (7.3025 cm). Other ranges can be used.

In some embodiments, the anchor 102b may have a diameter of 0.5 inches (1.27 cm) to 1 inch (2.54 cm), the standard diameter of a latch bore 113. In other embodiments, the anchor 102b may have a diameter greater than 1 inch (2.54 cm). Other values may be used. As noted previously, the diameter of the anchor 102b may be distinct from the diameter of the first grasping member 102a, or these may be substantially the same.

In some embodiments, the diameter of the anchor 102b may be limited to the circumference of a latch bore 113 of the door 101.

The respective surfaces 104a, 104b of the plate insert 104 may be characterized as an engaging surface 104b and a non-engaging surface 104a. The plate insert 104 may further comprise rounded corners, or may comprise squared or sharply-angled corners. In some embodiments, the plate insert 104 may be configured to slidingly insert into a plate cutout 109 of the door 101 to further secure the first clutching apparatus 100a to the door 101 (see FIGS. 3-4). In this arrangement, the engaging surface 104b is inwardly facing and contactingly engages a base surface of the plate cutout 109. Once engaged, the plate insert 104 may be configured to prevent rotational movement of the first clutching apparatus 100a to assist a user in manipulating the door 101 and further assist in preventing inadvertent disengagement through frictional contact with the sidewalls of the plate cutout 109. In other embodiments, the engaging surface 104b and non-engaging surface 104a may be interchangeable, thereby allowing either surface to be in contact with door 101 through insertion of the plate insert 104 into the plate cutout 109.

It will be noted that, normally, the plate cutout 109 is provided to accommodate a recessed striker plate of a doorknob assembly, and is accordingly often masked off and not subjected to painting or other surface finishing. As such, the plate cutout 109, along with the associated bore aperture 112 and the latch bore 113, provide a particularly advantageous location to contactingly engage the door 101 for movement.

When the user inserts either the first grasping member 102a or the anchor 102b into the bore aperture 112 (as seen in FIGS. 3 and 4), the first clutching apparatus 100a may be designated as being in an engaged state. When removed from the bore aperture 112, the first clutching apparatus 100a may be designated as being in a disengaged state. Despite the first clutching apparatus 100a being in an engaged state, a user may still choose to refrain from manipulating a door 101 (as seen in FIGS. 3 and 4) until both the first clutching apparatus 100a and the second clutching apparatus 100b (as seen in FIG. 2) are inserted into the door 101, as shown in FIGS. 3 and 4, so as to decrease a likelihood of inadvertent disengagement of the first clutching apparatus 100a, damage to the first clutching apparatus 100a, or inadvertent defects from attempted manipulation while having only one clutching apparatus in an engaged state.

In some embodiments it may be conceivable to freely manipulate a door 101 while having only the first clutching apparatus 100a in an engaged state.

FIG. 2 shows the aforementioned second clutching apparatus 100b of the system in accordance with some embodiments. The second clutching apparatus 100b comprises a second grasping member 106, at least one anchoring pin 108, and a hinge insert 110 with opposing surfaces 110a, 110b. As before, the second grasping member 106, the at least one anchoring pin 108, and the hinge insert 110 may be fashioned either independently and subsequently joined or as a unified whole using any number of suitable fabrication processes.

The hinge insert 110 in FIG. 2 is similar to the plate insert 104 discussed above in FIG. 1, and is configured for insertion into a hinge cutout 114 of the door 101 (see FIGS. 3-4). For reference, the plate insert 104 is also sometimes referred to as a first plate insert and the hinge insert 110 is also sometimes referred to as a second plate insert.

The second clutching apparatus 100b may be comprised of any suitable material capable of sustaining the weight of solid or hollow core doors. The second grasping member 106, may be of any length or shape, and may comprise a smooth, contoured, or textured outer surface as required. The second grasping member 106 may have a hollow core 107 or may be formed of solid material throughout.

As before, the second grasping member 106 may have an outer gripping surface adapted to be grasped by a second hand of the user. In some embodiments, the second grasping member 106 may be contoured to fit the curvature of the user's fingers or may be smooth and substantially cylindrical as depicted in the embodiment of FIG. 2. In yet other embodiments, the second grasping member 106 may comprise a contact surface having increased friction properties. The friction may be caused by a material configured to improve a user's grip on the surface in contact with the user's hand, such materials could be sandpaper or rubber but are not limited, and may be adhered to, fastened to, or otherwise joined with an outer surface of the second grasping member 106. Alternatively, the increased friction force may be facilitated by a material embedded in the second grasping member 106 or by one or more protrusions (not shown) extending from the outer surface of the second grasping member 106.

The anchoring pin(s) 108 of the second clutching apparatus 100b may be of any length or shape and may be smooth, contoured, or textured as required. Each anchoring pin 108 may be comprised of the same material as the second grasping member 106 or of a different material configured to fasten the second clutching apparatus 100b in the hinge cutout 114 (FIGS. 3-4). The anchoring pin(s) 108 can insertingly engage pin apertures 116 that extend into the door from the hinge cutout 114 to accommodate fasteners (e.g., threaded hardware, etc.) used to accommodate hinges (not shown) used to hang the door upon installation.

The respective surfaces 110a, 110b of the hinge insert 110 may be characterized as an engaging surface 110b and a non-engaging surface 110a. In some embodiments, the engaging surface 110b may be placed in facing relation to the door as the hinge insert 110 is nestingly inserted into the hinge cutout 114 to further secure the second clutching apparatus 100b to the door 101. Once engaged, the plate insert (110a, 110b) may be configured to prevent rotational movement of the second clutching apparatus 100b to assist a user in manipulating the door 101 and further assist in preventing inadvertent disengagement.

As with the plate cutout 109, the hinge cutout 114 is recessed to accommodate the attached hinge and is thus masked off and not normally subjected to paint or other surface treatment, making the hinge cutout 114 a particularly suitable location for the manipulation of the door 101 by the user. While only the topmost hinge cutout is shown in FIGS. 3-4, it will be understood that doors such as 101 often have multiple hinge cutouts, such as three (3) cutouts. In such case, the second clutching apparatus 100b can be advantageously inserted into any of the cutouts to provide a gripping surface for the user at a desired elevation. While not illustrated, it is contemplated that multiple second clutching apparatuses 100b can be used, each inserted into a different one of the hinge cutouts 114 if additional stability or gripping surfaces are required for a particular door.

When a user inserts the at least one anchoring pin 108 and the plate insert 110 into the hinge cutout 114 (as seen in FIGS. 3 and 4), the second clutching apparatus 100b may be designated as being in an engaged state. When removed from the hinge cutout 114, the second clutching apparatus 100b may be designated as being in a disengaged state. Despite the second clutching apparatus 100b being in an engaged state, a user may still choose to refrain from manipulating the door 101 until both the first clutching apparatus 100a (FIG. 1) and the second clutching apparatus 100b are inserted into the door 101, as shown in FIGS. 3 and 4, so as to decrease a likelihood of inadvertent disengagement of the second clutching apparatus 100b, damage to the second clutching apparatus 100b, or inadvertent defects from attempted manipulation while having only one clutching apparatus (100a or 100b) in an engaged state.

In some embodiments it may be conceivable to freely manipulate the door 101 while having only the second clutching apparatus 100b in an engaged state.

As noted previously, FIGS. 3 and 4 show the door 101 having a system for guiding and translocating the door in an engaged state, according to an embodiment of the present disclosure. As shown, the anchor 102b of the first clutching apparatus 100a is positioned within the bore aperture 112 of the door 101. As further depicted, the second clutching apparatus 100b is positioned within the hinge cutout 114, and the at least one anchoring pin 108 are positioned within the anchoring pin apertures 116.

As noted previously, FIGS. 5a-5c show an alternative configuration for the first clutching apparatus 100a of FIG. 1. In this case, the anchor 102a has a smaller diameter than the first grasping member 102a. Depending on the respective sizes of the elements, the anchor 102a may be sized to be slidingly nested within the core 107 of the second grasping member 106 so that the two elements 100a, 100b can be adjoined as a unified set when not in use.

Similarly, FIGS. 6a-6c show an alternative configuration for the second clutching apparatus 100b of FIG. 2. In this case, the second grasping member 107 has the aforementioned open core 107 and shorter pins 108.

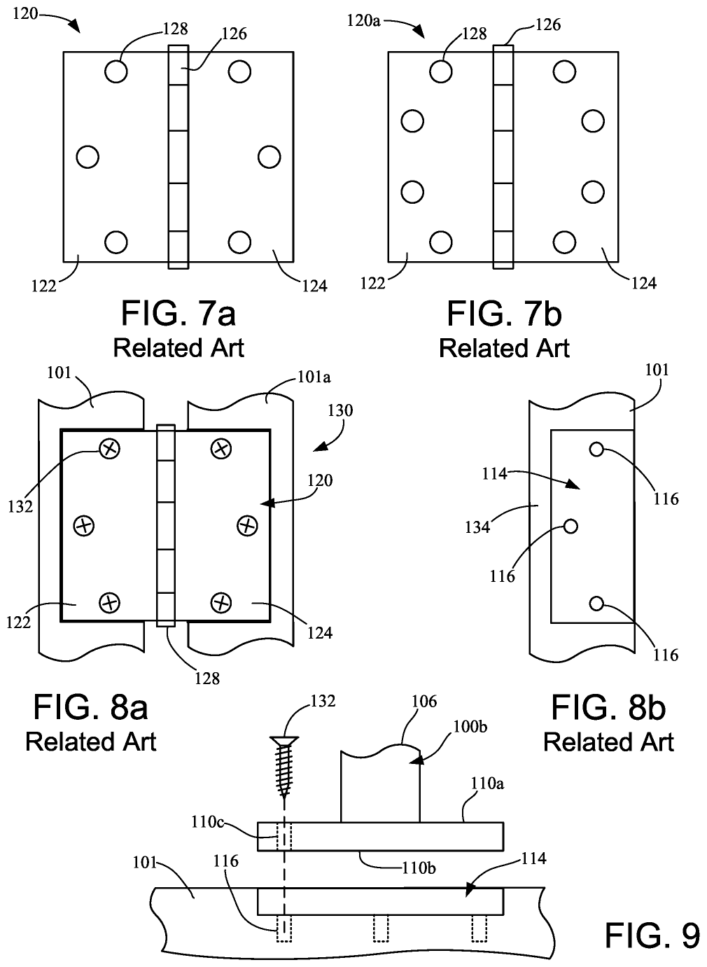

FIGS. 7a and 7b illustrate a pair of hinges 120, 120a as generally known in the art that can be respectively used with the door 101 of FIGS. 3-4 in some embodiments. The respective hinges 120, 120a are substantially similar and are configured to be installed within the respective hinge cutouts 114 discussed above to hang the door 101 in a doorframe (not shown). Each of the hinges 120, 120a have a pair of opposing plates 122, 124 moveable about a central hinge pin 126. While the hinges 120, 120a have the same overall size, the hinge 120 in FIG. 7a has three (3) apertures 128 in each plate 122, 124, while the hinge 120a in FIG. 7b has four such apertures 128. The apertures 128 are adapted to accommodate hardware, such as threaded fasteners, and nominally align with the pin apertures 116 that extend inwardly from each of the hinge cutouts 114 (FIGS. 3-4).

FIG. 8a shows a door assembly 130 in which the hinge 120 from FIG. 7a has been installed to mount the door 101 to a door frame 101a. Fasteners 132 have been installed in the respective apertures 128. While not limiting, it is contemplated that the fasteners 132 are wood screws and the apertures 128 are countersunk to provide a flush installation. Other arrangements can be used.

FIG. 8b shows an edge of the door 101 in further embodiments to illustrate various features of a selected one of the hinge cutouts 114. The hinge cutout 114 is shown to open on one side to facilitate operation of the hinge 120 as depicted in FIG. 8a. Stated another way, a strip of door material 134 extends along the closed side of the hinge cutout 114, and the hinge cutout can be viewed as constituting four (4) interior sidewalls.

It will be appreciated that the pin apertures 116 in the door 101 are aligned with the hinge apertures 128 in the associated hinge 120; hence, three pin apertures 116 are shown in FIG. 8b. Use of the hinge 120a in FIG. 7b would provide a four-hole pattern for the apertures 116 in the door 101.

It is contemplated although not necessarily required that, in the process of preparing and installing the door 101, various steps will take place including the cutting of the various openings in the door (e.g., plate cutout 109, bore aperture 112, latch bore 113, latch cutout 114). These various openings may be of standard size, or may have customized sizes based on the respective hardware (e.g., door latch assembly, hinges, deadbolt locks, etc.) to be installed into the door. These various openings may be formed prior to the painting or other surface processing of the door's 101 outer surfaces. While not required, it is contemplated that the respective openings required to install the hardware, such as the pin apertures 116 used to accommodate the fasteners 132, may be drilled during the formation of the other openings, and hence, available for use by the second clutching apparatus 110b during surface processing of the door.

As noted above, the second clutching apparatus 110b is provided with one or more anchoring pins 108 that can be inserted into the pin apertures 116. From FIGS. 7a-7b, it can be seen that the hinges 120, 120a have the uppermost and lowermost hinge apertures 128 in the same relative location. As such, some embodiments provide the anchoring pins 108 at these standardized locations.

In an alternative embodiment, the second clutching apparatus 100b is supplied with interchangeable components including a variety of hinge inserts 110 with anchoring pins 108 in different relative locations. This allows the user to select, install and use an appropriate anchoring pin configuration for a particular door.

In still further embodiments, the hardware (screws 132) can be used to secure the second clutching apparatus 110b to the door 101, as generally illustrated in FIG. 9. For reference, the orientation in FIG. 9 is rotated 90 degrees with respect to the orientation in FIGS. 3-4. In this case, the hinge insert 110 can be provided with apertures 110c that align with at least one of the pin apertures 116. The user can insert the hinge insert 110 into the hinge cutout 114 and use the same threaded hardware 132 to attach the second clutching apparatus 100b to the door 101 as will be subsequently used to attach the hinge 120 to the door.

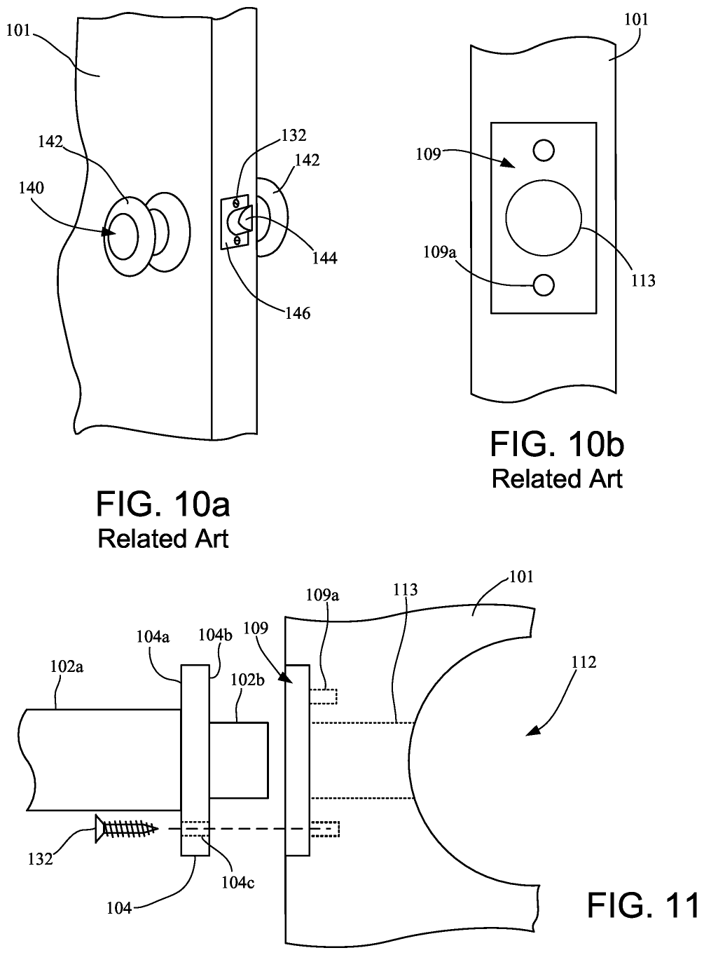

FIG. 10a shows the door 101 with an installed door latch assembly 140. The door latch assembly 140 occupies the aforedescribed plate cutout 109, bore aperture 112, and latch bore 113 within the door 101, and includes respective door knobs 142, a spring biased latching member 144, and a latch plate 146. Other forms of door latch assemblies can be used as desired. As noted previously, the latch plate 146, as well as the plate insert 104 of the first clutching apparatus 100a, are sized to fit within the plate cutout 109.

FIG. 10b shows an edge view of the door 101 with the door latch assembly 140 removed. This view illustrates the relative locations and sizes of the plate cutout and the latch bore 113. A pair of upper and lower apertures 109a extend into the door 101 from the latch cutout 109 to accommodate the fasteners 132 (FIG. 10a). The latch cutout 109 is fully surrounded by the door material and can be viewed as having five (5) interior sidewalls.

FIG. 11 provides an elevational view of the door 101 in conjunction with the first clutching apparatus 100a in accordance with further embodiments. In this case, a shortened anchor 102b is provided to secure the first clutching apparatus 100a to the door 101 resulting from insertion of the plate insert 104 into the plate cutout 109. As desired, one or more of the fasteners 132 can pass through associated apertures 109c formed in the plate insert 104, so that, as with the hinges discussed above, the first clutching apparatus 100a can use threaded hardware to further secure the first clutching apparatus to the door. While not shown, further embodiments can utilize the fastener(s) 132 without the anchor 102b to secure the first grasping surface 102a to the door.

The previous description of the disclosed embodiments is provided to enable any person skilled in the art to make or use the claimed subject matter. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for guiding and translocating a door having a latch bore and a hinge cutout, the system comprising:
a first clutching apparatus configured for contacting insertion into the latch bore of the door, the first clutching apparatus comprising a first grasping member, an anchor positioned opposite the first grasping member, and a plate insert positioned between the first grasping member and the anchor; and
a second clutching apparatus configured for contacting insertion into the hinge cutout of the door, the second clutching apparatus comprising a second grasping member, at least one anchoring pin positioned opposite the second grasping member, and a hinge insert positioned between the second grasping member and the at least one anchoring pin.

2. The system of claim 1, wherein the plate insert of the first clutching apparatus is configured to be nestingly received within a plate cutout of the door adjacent the latch bore, the anchor of the first clutching apparatus is configured to contactingly extend through the latch bore, and the first grasping member provides a first outer grip surface configured to be grasped by a first hand of a user during movement of the door.

3. The system of claim 1, wherein the hinge insert of the second clutching apparatus is configured to be nestingly received within the hinge cutout of the door, the anchoring pin is configured to contactingly extend into an anchoring pin aperture adjacent the hinge cutout, and the second grasping member provides a second outer grip surface configured to be grasped by a second hand of the user during movement of the door.

4. The system of claim 1, wherein the first grasping member, the anchor and the plate insert are seamlessly integrated, and the second grasping member, at least one anchoring pin, and hinge insert are seamlessly integrated.

5. The system of claim 1, wherein the first grasping member, the anchor and the plate insert are modular components configured to seamlessly couple and form a first cohesive unit, and the second grasping member, at least one anchoring pin, and hinge insert are modular components configured to seamlessly couple and form a second cohesive unit.

6. The system of claim 1, wherein the plate insert urges the first clutching apparatus against at least one surface of a plate cutout of the door to secure the first clutching apparatus against rotational movement relative to the door.

7. The system of claim 6, wherein the hinge insert urges the second clutching apparatus against at least one surface of the hinge cutout of the door to secure the second clutching apparatus against rotational movement relative to the door.

8. The system of claim 1, wherein at least one of the anchoring pins is configured to releasably engage with one or more anchoring pin apertures positioned within the hinge cutout to further secure the second clutching apparatus against rotational movement relative to the door, the anchoring pin apertures comprising preformed apertures configured to receive hardware to affix a hinge to the door.

9. The system of claim 1, wherein the first grasping member is characterized by a length of 0.254 cm to 7.3025 cm.

10. The system of claim 1, wherein the anchor is characterized by a length of 0.254 cm to 7.3025 cm.

11. The system of claim 1, wherein the first grasping member is further characterized by a diameter of 1.27 cm to 2.54 cm.

12. The system of claim 1, wherein anchor is further characterized by a diameter of 1.27 cm to 2.54 cm.

13. A system, comprising:
a door comprising a plate cutout, a latch bore extending from the plate cutout, a bore aperture extending through the door, a hinge cutout and at least one anchoring pin aperture extending from the hinge cutout;
a first clutching apparatus releasably mounted on the door comprising a first grasping member characterized by a length of 0.254 cm to 7.3025 cm, an anchor positioned opposite the first grasping member, and a plate insert positioned between the first grasping member and the anchor; and
a second clutching apparatus releasably mounted on the door, including a second grasping member, at least one anchoring pin positioned opposite the second grasping member, and a hinge insert positioned between the second grasping member and the at least one anchoring pin.

14. The system of claim 12, wherein the plate insert urges the first clutching apparatus against at least one surface of a plate cutout of the door to secure the first clutching apparatus against rotational movement relative to the plate insert.

15. The system of claim 12, wherein the hinge insert urges the second clutching apparatus against at least one surface of the hinge cutout of the door to secure the second clutching apparatus against rotational movement relative to the hinge insert.

16. The system of claim 12, wherein at least one anchoring pin is configured to engage with one or more anchoring pin apertures positioned within the hinge cutout to further secure the second clutching apparatus against rotational movement relative to the hinge insert.

17. The system of claim 12, wherein the first grasping member has a length of from 0.254 cm to 7.3025 cm and a diameter of from 1.27 cm to 2.54 cm, and the anchor has a length of from 0.254 cm to 7.3025 cm and a diameter of from 1.27 cm to 2.54 cm.

18. The system of claim 12, wherein the anchor extends from an engaging surface of the plate insert, and when affixed to the door, traverses through the latch bore, terminating within the bore aperture, and the first grasping member extends from a non-engaging surface of the plate insert, and when affixed to the door, extends in a direction opposite to that of the anchor, relative to the latch bore.

19. The system of claim 12, wherein the first grasping member extends from an engaging surface of the plate insert, and when affixed to the door, traverses through the latch bore, terminating within the bore aperture, and the anchor extends from a non-engaging surface of the plate insert, and when affixed to the door, extends in a direction opposite to that of the first grasping member, relative to the latch bore.

20. A method, comprising:
inserting a portion of a first clutching apparatus in a latch bore of a door until a plate insert of the first clutching apparatus is within a plate cutout on the door;
inserting at least one anchoring pin of a second clutching apparatus in at least one anchoring pin aperture of the door until a hinge plate of the second clutching apparatus is within a hinge cutout on the door; and
applying a lifting force on the first clutching apparatus and second clutching apparatus to maneuver the door.

21. The method of claim 19, wherein the portion of the first clutching apparatus inserted into the latch bore is one of a first grasping member or an anchor.
